(19) United States
(12) Patent Application Publication
(10) Pub. No.: US 2026/0171093 A1
(43) Pub. Date: Jun. 18, 2026

(54) METHOD AND APPARATUS FOR COMBINING TRANSCRIBED UTTERANCE AND PUNCTUATION

(71) Applicants: HYUNDAI MOTOR COMPANY, Seoul (KR); KIA CORPORATION, Seoul (KR)

(72) Inventors: Eun Mi Seo, Hwaseong-si (KR); Tae Jun Park, Hwaseong-si (KR)

(73) Assignees: HYUNDAI MOTOR COMPANY, Seoul (KR); KIA CORPORATION, Seoul (KR)

(21) Appl. No.: 19/216,413

(22) Filed: May 22, 2025

(30) Foreign Application Priority Data
Dec. 16, 2024 (KR) 10-2024-0186775

(51) Int. Cl. G10L 15/26; G10L 15/16; G10L 25/18

(52) U.S. Cl. CPC G10L 15/26; G10L 15/16; G10L 25/18

(57) ABSTRACT

A method and apparatus combine a transcribed utterance and punctuation. A method for combining a transcribed utterance and punctuation using a pre-trained sentence type classification model includes receiving, from a microphone in a vehicle, a speech signal representing an utterance input captured by the microphone. The method further includes converting the speech signal or a spectrogram generated based on the speech signal into a sentence using at least one speech recognizer. The method also includes classifying the sentence into a type of sentence corresponding to the speech signal or the spectrogram using the pre-trained sentence type classification model. The method further includes inserting punctuation into the sentence based on the type of sentence. The method also includes generating a text-based combined result based on a combination of the sentence and the inserted punctuation.

### CROSS-REFERENCE TO RELATED APPLICATION

This application claims the benefit of and priority to Korean Patent Application No. 10-2024-0186775, filed in the Korean Intellectual Property Office on Dec. 16, 2024, the entire disclosure of which is incorporated herein in its entirety by reference.

### TECHNICAL FIELD

The present disclosure relates to a method and apparatus for combining a transcribed utterance and punctuation. More specifically, the present disclosure relates to a method and apparatus for combining a transcribed utterance and punctuation using a pre-trained sentence type classification model.

### BACKGROUND

The content described in this section merely provides background information related to the present embodiment and does not constitute prior art.

As speech recognition programs and apparatuses have been developed, conversational applications and apparatuses based on generative artificial intelligence (AI) may interact with users in various services. Conversational applications and apparatuses convert user's utterances into text-based sentences and analyze them to generate appropriate responses. Speech recognition apparatuses have been mainly used to process command sentences. However, as generative AI has further developed, the number of cases in which processing utterances in the form of interrogative sentences have increased. As the number of utterances in the form of interrogative sentences increases, there is a technical problem in which speech recognition apparatuses are not able to distinguish whether generative AI should respond, based on a user's utterance, to a command sentence or to an interrogative sentence. This technical problem occurs because conventional speech recognition apparatuses fail to insert proper punctuation appropriate for the type of sentence converted from an utterance. In other words, there is a technical problem in which conventional speech recognition apparatuses categorize a user's utterance only as a declarative sentence.

To solve the difficulty of punctuation recognition, conventional speech recognition apparatuses provide two approaches. First, a user directly utters a punctuation mark, such as a question mark or an exclamation mark. However, in the case of declarative sentences, the function of automatically inserting a period at the end of a sentence causes inconvenience to the user. Second, punctuation marks are inserted using post-processing by identifying the context of a sentence recognized as a declarative sentence using natural language processing (NLP).

In the first method, since a user needs to directly utter the punctuation mark, the natural flow of conversation may be interrupted. There is also a technical problem in which conventional speech recognition apparatus do not perform accurate sentence processing when punctuation marks are omitted. In the second method, the accuracy of context identification decreases in complex sentence structures or irregular utterances. Inaccurate context identification by conventional speech recognition apparatuses leads to insertion of incorrect punctuation marks or omission of punctuation marks.

In particular, conventional speech recognition apparatuses have several technical issues. First, conventional speech recognition apparatuses often do not accurately identify a user's intent. In the case of a question or an exclamation, the intent of the utterance is not accurately identified, resulting in misrecognition. There are cases in which an utterance is recognized only as a declarative sentence and a response result different from the user's intent is generated. This causes technical problems since a user request is not accurately delivered or is not properly processed. In particular, if an inaccurate response is an output for utterances related to a vehicle state, user safety and satisfaction is reduced. For example, conventional speech recognition apparatuses do not provide accurate responses for utterances related to vehicle states such as refueling, tire pressure, washer fluid, urea water, and car washing.

Second, there is a technical problem in which punctuation marks are not accurately recognized by conventional speech recognition apparatuses. Conventional speech recognition apparatuses often fail to insert proper punctuation marks due to processing sentences only as declarative sentences when converting utterances into text-based sentences. For example, punctuation marks such as question marks or exclamation marks are omitted. This omission reduces the quality and reliability of responses using generative AI.

Third, there is a technical problem in which conventional speech recognition apparatuses do not provide accurate data as input to a subsequent engine that receives speech recognition results. If a speech recognition result does not match a user's actual utterance, a technical problem occurs in which an incorrectly recognized speech recognition result is transmitted to a natural language understanding (NLU) engine. This causes errors in delivery of the meaning of an utterance. Therefore, the naturalness and accuracy of outputs as a result of using Text-to-Speech (TTS) is reduced.

Fourth, there is a technical problem in which conventional speech recognition apparatuses do not recognize special symbols other than punctuation marks. In particular, conventional speech recognition apparatuses do not recognize special symbols such as ellipses ( . .. ) or tildes (˜) in addition to punctuation marks.

Fifth, there is a technical problem in terms of the scalability and cost of a speech recognition model. To add the function of recognizing punctuation marks or improving performance, it is necessary to change the speech-to-text (STT) engine or construct a large amount of training data. This leads to problems such as excessive development costs and time.

Sixth, there is a technical problem of delays by the conventional speech recognition apparatuses in the inference process. Conventional speech recognition apparatuses perform follow-up processing based on speech recognition results. This causes a technical problem of delayed calculation and inefficient use of processor resources. When a large-scale model is used, the problem of delayed calculation and inefficient use of processor resources becomes more serious.

### SUMMARY

An objective of the disclosed embodiments is to provide a speech recognition apparatus and method for classifying the type of utterance received from a user and automatically combining punctuation appropriate for the type of utterance received from the user.

The disclosed embodiments solve problems which uniquely arise in the field of speech recognition technology by providing a speech recognition apparatus and method that automatically combine punctuation, such as an exclamation mark or a question mark, into a sentence when the type of utterance is an exclamatory sentence or an interrogative sentence. In particular, the disclosed embodiments provide a method and an apparatus for combining a transcribed utterance and punctuation, which accurately recognizes a sentence converted from a user's utterance and accurately process a user request based on a sentence type.

The disclosed embodiments also provide a method and an apparatus for classifying a sentence converted from a user's utterance into a declarative sentence, an interrogative sentence, or an exclamatory sentence using a pre-trained sentence type classification model and combining punctuation appropriate for the sentence type with the sentence.

The disclosed embodiments further provide a method and an apparatus for combining a transcribed utterance and punctuation, which provides accurate data to an NLU or TTS engine that receives a sentence converted from a user's utterance by combining punctuation appropriate for the type of a sentence and the sentence.

The disclosed embodiments also provide a method and an apparatus for combining a transcribed utterance and punctuation, which expands a function of recognizing other special symbols that are appropriate for the context of an utterance in addition to punctuation by classifying the sentence type and combining appropriate punctuation.

The disclosed embodiments further provide a method and an apparatus for combining a transcribed utterance and punctuation, which adds new functions without the cost of changing a speech recognizer or constructing large-scale training data by using a speech recognizer and a pre-trained sentence type classification model in parallel.

In addition, the disclosed embodiments provide a method and an apparatus for combining a transcribed utterance and punctuation, which solves the technical problem of computational delay and efficiently uses processor resources by improving the processing speed in the inference process by using a speech recognizer and a pre-trained sentence type classification model in parallel.

Therefore, the disclosed embodiments provide a specific and practical application which improves upon prior speech recognition apparatuses and provides additional functionality not previously provided.

The objectives to be achieved by the present disclosure are not limited to the objectives described above, and other objectives not explicitly mentioned should be apparent to those of ordinary skill in the art from the following description.

According to an aspect of the present disclosure, there is provided a method for combining a transcribed utterance and punctuation using a pre-trained sentence type classification model. The method comprises receiving, from a microphone in a vehicle, a speech signal representing an input utterance captured by the microphone. The method further comprises converting the speech signal or a spectrogram generated based on the speech signal into a sentence using at least one speech recognizer. The sentence represents a transcription of the input utterance to text. The method also comprises classifying the sentence into a type of sentence corresponding to the speech signal or the spectrogram using the pre-trained sentence type classification model. The method further comprises inserting punctuation into the sentence based on the type of sentence. The method also comprises generating a text-based combined result based on a combination of the sentence and the inserted punctuation.

According to another aspect of the present disclosure, there is provided an apparatus for combining a transcribed utterance and punctuation using a pre-trained sentence type classification model. The apparatus comprises a memory configured to store computer-executable instructions. The apparatus further comprises at least one processor configured to execute the computer-executable instructions to receive a speech signal from a microphone in a vehicle. The speech signal represents an input utterance captured by the microphone. The at least one processor is further configured to convert the speech signal or a spectrogram generated based on the speech signal into a sentence using at least one speech recognizer. The sentence represents a transcription of the input utterance to text. The at least one processor is further configured to classify the sentence into a type of sentence corresponding to the speech signal or the spectrogram using the pre-trained sentence type classification model, and insert punctuation into the sentence based on the type of sentence. The at least one processor is further configured to generate a text-based combined result based on a combination of the sentence and the inserted punctuation.

The disclosed embodiments of the present disclosure enhance the accuracy of natural sentence generation and processing based on user's utterances by accurately recognizing and processing a user's intent based on the type of sentence.

The disclosed embodiments of the present disclosure classify a sentence into a declarative sentence, an interrogative sentence, or an exclamatory sentence using the pre-trained sentence type classification model and automatically apply the appropriate punctuation to the sentence.

The disclosed embodiments of the present disclosure output a response appropriate for a user request by transmitting speech recognition data that matches the intent of the user's utterance to a subsequent processing engine as an input value.

The disclosed embodiments of the present disclosure provide a highly scalable speech recognition apparatus and method capable of recognizing special symbols other than punctuation marks in accordance with the context and combining them with sentences.

The disclosed embodiments of the present disclosure reduce system development costs and improve efficiency by using a speech recognizer and a pre-trained sentence type classification model in parallel, without the need to replace the speech recognizer or build new training data.

The disclosed embodiments of the present disclosure improve processing speed and efficiently allocate processor resources by using a speech recognizer and a pre-trained sentence type classification model in parallel.

The effects of the present disclosure are not limited to the above-mentioned effects. Other effects not mentioned should be clearly understood by those of ordinary skill in the art from the description below.

### BRIEF DESCRIPTION OF THE DRAWINGS

FIG. 1 is a functional block diagram of a speech recognition apparatus according to an embodiment of the present disclosure.

FIG. 2 is a diagram schematically showing a relationship between a vehicle and the speech recognition apparatus according to an embodiment of the present disclosure.

FIG. 3 is a diagram illustrating a speech recognition module according to an embodiment of the present disclosure.

FIG. 4A is a diagram illustrating a conventional method for recognizing an utterance of a user.

FIG. 4B is a diagram illustrating a method of combining a transcribed utterance and punctuation according to an embodiment of the present disclosure.

FIG. 5 is a flowchart illustrating the method of combining a transcribed utterance and punctuation according to an embodiment of the present disclosure.

FIG. 6 is a configuration diagram of a speech recognition apparatus according to an embodiment of the present disclosure.

### DETAILED DESCRIPTION

Hereinafter, various embodiments of the present disclosure are described in detail below with reference to the accompanying drawings. In the drawings, the same reference numerals are used throughout to designate the same or equivalent elements, even though the elements are shown in different drawings. Further, in the following description of various embodiments, a detailed description of well-known functions and configurations incorporated therein is omitted for the purpose of clarity and for brevity.

Additionally, various terms such as first, second, A, B, (a), (b), and the like are used solely to distinguish one component from another, and do not imply or suggest the type, order, or sequence of the components. Throughout this specification, when a part ‘includes’ or ‘comprises’ a component, it is to be understood that the part may further include other components, unless specifically stated otherwise.

When a component, device, element, part, unit, module or the like of the present disclosure is described as having a purpose or performing an operation, function, or the like, the component, device, or element should be considered herein as being “configured to” meet that purpose or to perform that operation or function. Each “part”, “unit”, “module”, “component”, “device”, “element”, and the like may separately embody or be included with a processor and a memory, such as a non-transitory computer readable media, as part of the apparatus.

The following detailed description, together with the accompanying drawings, is intended to describe various embodiments of the present disclosure and is not intended to limit the scope of the present disclosure to the embodiments described herein.

Hereinafter, a speech recognition apparatus refers to an apparatus that combines transcribed utterances with punctuation.

Hereinafter, a user refers to a driver or a passenger of a vehicle.

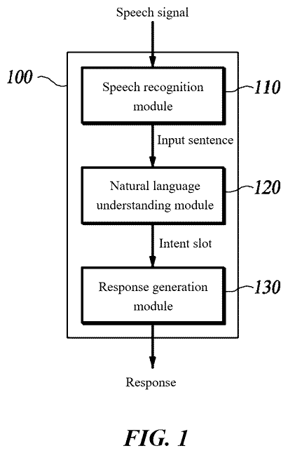

FIG. 1 is a functional block diagram illustrating a speech recognition apparatus according to an embodiment of the present disclosure.

As illustrated in FIG. 1, the speech recognition apparatus 100 according to an embodiment of the present disclosure may include some or all of a speech recognition module 110, a natural language understanding module 120, and a response generation module 130.

The speech recognition apparatus 100 recognizes and understands a user's utterance and provides a response corresponding to the user's utterance. The speech recognition apparatus 100 includes the speech recognition module 110 that transcribes an input utterance, e.g., a user's utterance, and speech command into transcribed text and classifies the type of the transcribed text. The speech recognition apparatus 100 further includes a natural language understanding module 120 that determines the intent of the user's utterance. The speech recognition apparatus 100 also includes the response generation module 130 that generates a response, i.e., a text-based response output, corresponding to the intent of the user's utterance. The speech recognition module 110 may be referred to as an automatic speech recognition (ASR) engine. The speech recognition module 110 may include at least one speech recognizer and a pre-trained sentence type classification model. The speech recognizer may be referred to as a speech-to-text (STT) engine. The speech recognition module 110 may simultaneously perform speech recognition and sentence type classification using the speech recognizer and the pre-trained sentence type classification model, thereby improving the processing speed. Since the two operations are performed independently, processor resources such as a CPU and a GPU may be efficiently allocated to enhance the system performance.

To enable sentence type classification, a speech signal (i.e., waveform) received from a microphone is segmented and used directly or converted into a spectrogram to be input into the sentence type classification model. The model may consist of a neural network, such as a convolutional neural network (CNN) or a transformer-based encoder, which extracts sentence-level features from the waveform or spectrogram input. A classification layer then assigns a sentence type label, such as declarative, interrogative, or exclamatory.

The sentence type classification model may be pre-trained using a labeled speech-text corpus in which each utterance is annotated with its corresponding sentence type. During training, each utterance may be converted into Mel-frequency cepstral coefficients (MFCCs), which are widely used in speech recognition, and the MFCCs may be used as feature vectors for training the model. The model learns to associate MFCC patterns with sentence types and may be fine-tuned to improve performance under various speaking styles or background noise conditions. In real-time applications, the trained model may instead process waveform or spectrogram inputs, which are more suitable for real-time processing environments.

Once deployed, the pre-trained model classifies sentence types in real time using the incoming speech signal. The sentence type label is then used to guide downstream processes, such as inserting appropriate punctuation in transcribed text or generating an output command for controlling a device or vehicle. This flow from signal processing through classification to a practical response shows that the invention is implemented as a technical improvement to speech understanding and control systems, rather than as a mere abstract idea.

A microphone installed in a vehicle acquires or captures an input utterance, e.g., a user's utterance, and converts the input utterance to a speech signal. The speech recognition module 110 receives the speech signal representing the input utterance from the microphone installed in the vehicle and transcribes the speech signal representing the input utterance into an input sentence, i.e., a sequence of words, using at least one STT engine. The speech recognition module 110 may generate a spectrogram by converting the speech signal into a spectrogram using a conversion program. The conversion program for converting the speech signal into a spectrogram may be stored in a memory and/or a storage of the speech recognition apparatus 100. The STT engine may transcribe the speech signal representing the input utterance or the spectrogram obtained from the speech signal into a sentence using a speech recognition algorithm or a deep learning model. For example, the speech recognition module 110 may extract a feature vector from the input utterance by using a feature extraction method such as Cepstrum, Linear Predictive Coefficient (LPC), Mel Frequency Cepstral Coefficient (MFCC), or Filter Bank Energy.

The speech recognition module 110 may obtain recognition results by comparing the extracted feature vector with trained reference patterns. To this end, an acoustic model that models and compares the signal characteristics of speech or a language model that models the linguistic order relationship of words or syllables corresponding to recognized vocabularies may be used.

The speech recognition module 110 may also convert the user's utterance into a text-based sentence based on a model trained with machine learning or deep learning.

The speech recognition module 110 may receive a speech signal or a spectrogram and output a type of sentence corresponding to the speech signal or the spectrogram using a pre-trained sentence type classification model.

The speech recognition module 110 may combine the sentence converted from the user's utterance by the speech recognizer and punctuation marks based on the type of sentence classified by the pre-trained sentence type classification model. Before speech recognition, the speech recognition module 110 may preprocess the speech signal corresponding to the user's utterance. For example, the speech recognition module 110 may perform preprocessing for reducing noise in the speech signal.

The natural language understanding module 120 classifies the intent of the user's utterance from the input sentence using at least one natural language understanding (NLU) engine and extracts a slot representing semantic information related to the intent of the utterance.

A slot refers to a semantic slot necessary to provide a response according to an utterance intent. A slot may be defined in advance for each utterance intent. The role of a slot is determined according to utterance intent. For example, in an input sentence “Guide me to Yanghwa Bridge”, “Yanghwa Bridge” may represent a point of interest, but in an input sentence “Play Yanghwa Bridge”, “Yanghwa Bridge” may represent a song title.

In an embodiment, the NLU engine may compare the input sentence with a preset grammar to determine the intent of the user's utterance and slot for the input sentence. For example, when the preset grammar is “Call <who>” and an input sentence is “Call Hong Gil-dong”, the NLU engine may determine that the utterance intent is “Make a call” and the slot value is “Hong Gil-dong”.

In another embodiment, the NLU engine may determine the intent of the user's utterance and slot for the input sentence using tokenization, a deep learning model, or the like.

Specifically, the NLU engine segments the input sentence into tokens at a morpheme level. A morpheme is a minimal unit that has a meaning but may not be further segmented. The NLU engine may tag each token with a part of speech.

The NLU engine maps the tokens to a vector space. Each token or a combination of tokens is transformed into an embedding vector. To improve performance, sequence embedding, position embedding, etc. may be performed together.

The NLU engine determines the utterance intent and slot for the input sentence by grouping embedding vectors or applying a first deep learning model and a second deep learning model to the embedding vectors. The first deep learning model may be a recurrent neural network (RNN) pre-trained to classify the intent of an utterance in response to input of embedding vectors. The second deep learning model may be a recurrent neural network pre-trained to determine a slot in response to input of the embedding vectors.

The natural language understanding module 120 may extract a domain, a named entity, or a speech act from a sentence using the NLU engine.

A domain is information for identifying the subject of a user's utterance. For example, domains representing various subjects such as vehicle control, information provision, text transmission, and navigation functions may be determined based on sentences.

A named entity refers to a proper noun such as a person's name, a place name, an organization name, time, date, currency, or the like. Named entity recognition (NER) is an operation that identifies a named entity from a sentence and classifies the identified named entity into a type. The NLU engine may extract important keywords from a sentence using named entity recognition to understand the meaning of the sentence.

Speech act analysis is a task for analyzing the intent of an utterance. Speech act analysis is used to identify the intent behind an utterance, such as whether a user is asking a question, making a request, giving a response, or simply expressing an emotion.

Information such as a domain, a named entity, or a speech act may be used for at least one of classifying the intent of a user's utterance, determining a slot, or generating a response to the user's utterance.

The response generation module 130 performs processing of providing a response corresponding to the intent of a user's utterance. The response generation module 130 may provide responses in various forms. The response generation module 130 may provide a response to a user's utterance using a visual, auditory, or tactile interface.

The response generation module 130 may generate response information that is easily understood by the user by using a generative model. The response generation module 130 may generate a complete sentence from information such as an utterance intent, a slot, a domain, a named entity, and a speech act by using a generative model. For example, if the intent of a user's utterance is “vehicle-related control”, the response generation module 130 may transmit a result processing signal for performing vehicle-related control to the vehicle.

In another example, if the intent of a user's utterance is “provision of specific information”, the response generation module 130 may search for the specific information using a slot and provide the searched information to a user terminal. The information search may also be performed using an external server.

In another example, if the intent of a user's utterance is “provision of specific content”, the response generation module 130 may request transmission of the target content from an external server that provides the content.

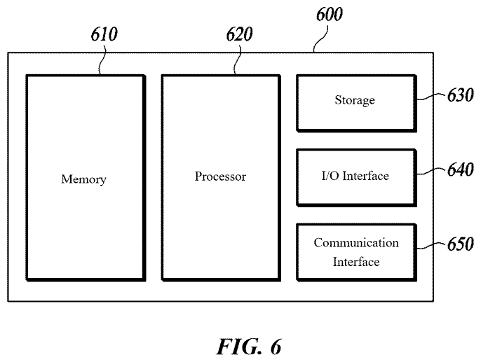

In another example, if the intent of a user's utterance is “engaging in a casual conversation”, the response generation module 130 may generate response content for the user's utterance and output the response visually or audibly. The operation of the response generation module 130 to output a response visually or audibly may be performed using the input/output interface of FIG. 6.

Examples of the operation of the speech recognition apparatus 100 are described below.

For example, when an input sentence is “When should I change the engine oil?”, the NLU engine tokenizes the input sentence into words of “engine”, “oil”, “when”, “change”, and “do”, and converts each word into a vector. The NLU engine classifies the intent of an utterance corresponding to vectors based on the similarity between vectors and positions in the vector space. In the example above, the classified utterance intent is “Check consumable replacement”. The NLU engine extracts slot values of “engine” and “oil” based on the intent of “Check consumable replacement”. Thereafter, the response generation module 130 may provide the sentence “The engine oil change cycle is 15,000 km” based on the intent of checking consumable replacement and the slot values of “engine” and “oil”.

In another example, if an input sentence is “Let's go home”, the domain is “navigation”, the utterance intent is “route setting”, and the slots required to control according to the utterance intent are “starting point” and “destination”.

In another example, if an input sentence is “Turn on the air conditioner”, the domain is “vehicle control”, the utterance intent is “power on the air conditioner”, and the slot required to control according to the utterance intent is “air conditioner”. Additional slots may include “temperature” and “air volume”, depending on the specific control required.

The speech recognition apparatus 100 includes at least one processor and a memory configured to store at least one computer-executable instruction. The speech recognition apparatus 100 may perform functions of the speech recognition module 110, the natural language understanding module 120, and the response generation module 130 by executing instructions, i.e., computer-executable instructions, which are executed by at least one processor. The speech recognition apparatus 100 may further include a communication module for communicating with an external device.

Not all blocks illustrated in FIG. 1 are essential components, and some blocks included in the speech recognition apparatus 100 may be added, changed, or deleted in other embodiments. The components illustrated in FIG. 1 represent functionally distinguished elements, and one or more components may be integrated in an actual physical environment.

One of ordinary skill in the art should appreciate that one or more modules, e.g., the speech recognition module 110, the natural language understanding module 120, and the response generation module 130, the speech recognizer and the pre-trained sentence type classification model, described herein may be implemented using, among other things, a tangible computer-readable medium or non-transitory memory comprising computer-executable instructions (e.g., executable software code) executed by specifically configured hardware or processors, e.g., one or more processors 620 described in more detail with respect to FIG. 6. It should be appreciated that the disclosed embodiments may be implemented as a different or separate module of the speech recognition apparatus 100, or a separate computer system coupled with the speech recognition apparatus 100.

The sentence type classification model described above, which processes waveform or spectrogram input to output a sentence type label, may be implemented using executable software code stored in a non-transitory computer-readable medium. Further details regarding the pre-training, acoustic signal processing, and downstream use of the classification result are provided above.

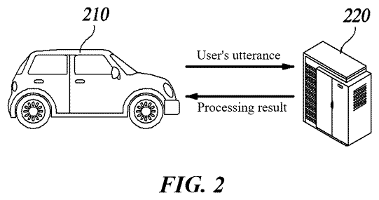

FIG. 2 is a diagram schematically showing a relationship between a vehicle and the speech recognition apparatus in accordance with an embodiment of the present disclosure. Referring to FIG. 2, the speech recognition apparatus 100 may be implemented using at least one of a vehicle 210 or a server 220. In an embodiment, the speech recognition apparatus 100 may be implemented in the vehicle 210. In other words, the vehicle 210 may include the speech recognition apparatus 100.

The speech recognition apparatus 100 in the vehicle 210 may acquire a user's utterance received through a microphone in the vehicle, recognize and understand the user's utterance, and provide a response corresponding to the user's utterance to the vehicle 210. The vehicle 210 may provide a response to the user using a speaker in the vehicle 210.

In an embodiment, the speech recognition apparatus 100 may be implemented in the server 220. A communication interface in the vehicle 210 may transmit a user's utterance or a speech command to the speech recognition apparatus 100 in the server 220. The speech recognition apparatus 100 processes the utterance or speech command to generate information or a control command required for the user and transmits the information or control command to the communication interface in the vehicle 210. The vehicle 210 may provide a response to the user using a speaker in the vehicle 210.

The speech recognition module 110, the natural language understanding module 120, and the response generation module 130 in the speech recognition apparatus 100 may be distributed in the vehicle 210 and the server 220.

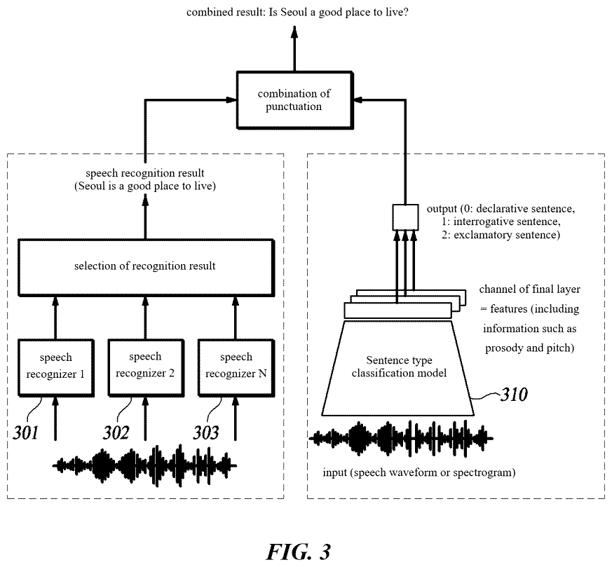

FIG. 3 is a diagram illustrating a speech recognition module 110 according to an embodiment of the present disclosure.

The speech recognition module 110 may include at least one speech recognizer 301, 302, and 303 and a pre-trained sentence type classification model 310. The speech recognition module 110 may select one of the results of processing of converting a user's utterance into a sentence by the plurality of speech recognizers 301, 302, and 303. The speech recognition module 110 may select one of the output results of the plurality of speech recognizers 301, 302, and 303, such as based on the accuracy of speech recognition. However, the criterion for selection is not limited to accuracy. The specific selection method is obvious to those of ordinary skill in the art, and thus detailed description is omitted.

The speech recognition module 110 inserts punctuation into a sentence converted from the user's utterance by the speech recognizer 301, 302, or 303, based on the sentence type classified by the sentence type classification model 310. The combined result, i.e., the text-based combined result, is a sentence selected from the sentences converted by the speech recognizers, with punctuation inserted according to the sentence type. In other words, the speech recognition module 110 generates a text-based combined result based on a combination of the sentence and the inserted punctuation. The speech recognition module 110 may insert punctuation into a sentence when the sentence is an interrogative or exclamatory sentence. This is because inserting a period into a declarative sentence would reduce user convenience. There may be three results of inserting punctuation into a sentence. First, if the speech recognition result selected from among the processing results of the speech recognizers 301, 302, and 303 is “Seoul is a good place to live” and the sentence type classification model 310 classifies the sentence as a declarative sentence, no period is inserted. The combined result is “Seoul is a good place to live”. Second, if the speech recognition result selected from among the processing results of the speech recognizers 301, 302, and 303 is “Seoul is a good place to live” and the sentence type classification model 310 classifies the sentence as an interrogative sentence, a question mark is inserted into the sentence. The combined result is “Is Seoul a good place to live?” Third, if the speech recognition result selected from among the processing results of the speech recognizers 301, 302, and 303 is “Seoul is a good place to live” and the sentence type classification model 310 classifies the sentence as an exclamatory sentence, an exclamation mark is inserted into the sentence. The combined result, i.e., the text-based combined result, is “Seoul is a good place to live!”

The speech recognizers 301, 302, and 303 may refer to STT engines. The speech recognizers 301, 302, and 303 may receive a speech signal or a spectrogram converted from a speech signal by the speech recognition module 110 using a spectrogram conversion program. The speech recognizers 301, 302, and 303 may convert a speech signal representing a user's utterance or a spectrogram converted from, i.e., generated based on, a speech signal into a sentence using a speech recognition algorithm or a deep learning model.

The sentence type classification model 310 is a model that receives a speech signal or a spectrogram and classifies a type of sentence using a neural network such as a convolutional neural network (CNN). The type of sentence may include a declarative sentence, an interrogative sentence, or an exclamatory sentence, and the like. The sentence type classification model 310 may receive, as input, a speech signal or a spectrogram converted from the speech signal using an in-vehicle microphone. The sentence type classification model 310 is a model trained to output the type of sentence corresponding to a speech signal or a spectrogram. The sentence type classification model 310 may include a layer that receives a speech signal or a spectrogram, process a waveform of the speech signal or the spectrogram, and extracts features including at least one of a prosody or a pitch. The sentence type classification model 310 may output a type of sentence with the highest probability among a declarative sentence, an interrogative sentence, and an exclamatory sentence using a softmax function. The softmax function outputs a probability for each class when classifying multiple classes. The output of the sentence type classification model 310 may include 0, 1, and 2, where 0 may represent a declarative sentence, 1 may represent an interrogative sentence, and 2 may represent an exclamatory sentence. The sentence type classification model 310 may classify the sentence type of a speech signal or a spectrogram by outputting the sentence type.

The speech recognizers 301, 302, and 303 and the sentence type classification model 310 may perform the speech recognition operation and the sentence type classification operation in parallel.

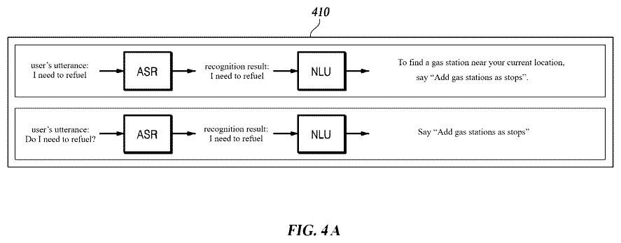

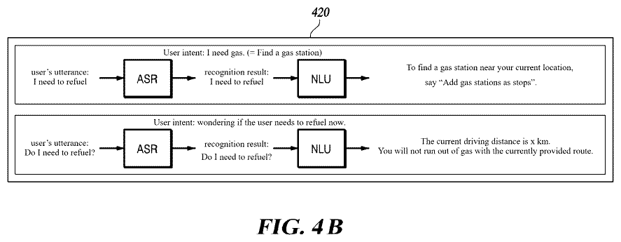

FIG. 4A is a diagram illustrating a conventional method for recognizing an utterance of a user.

A conventional speech recognition model 410 is a model that recognizes a user's utterance as speech using a conventional speech recognition apparatus. The conventional speech recognition model 410 does not recognize punctuation when the type of sentence converted from a user's utterance is an interrogative sentence or an exclamatory sentence. Since the conventional speech recognition model 410 inputs a sentence in the form of a declarative sentence into the natural language understanding (NLU) module regardless of the type of sentence, the response generation module may not accurately process the user's request. For example, first, when a user's utterance is “I need to refuel”, the sentence converted by the speech recognition module (ASR) is “I need to refuel”, and the response output by the response generation module using the intent slot output by the natural language understanding module may be “To find a gas station near your current location, say ‘Add gas stations as stops’”. Second, if a user's utterance is “Do I need to refuel?”, the sentence converted by the speech recognition module (ASR) is “I need to refuel”, and the response output by the response generation module using the intent slot output by the natural language understanding module may be “Say ‘Add gas stations as stops’”.

On the other hand, FIG. 4B is a diagram illustrating a method of combining a transcribed utterance and punctuation according to an embodiment of the present disclosure.

Referring to FIG. 4B, the speech recognition model 420 according to an embodiment of the present disclosure is a model that recognizes a user's utterance as speech using the speech recognition apparatus according to the present disclosure. The speech recognition model 420 according to an embodiment of the present disclosure may combine punctuation appropriate for the sentence type even when the type of sentence converted from a user's utterance is an interrogative sentence or an exclamatory sentence. The speech recognition model 420 according to an embodiment of the present disclosure inputs a sentence combined with punctuation corresponding to the type of sentence to the natural language understanding module, and thus the response generation module may accurately process the user request. The speech recognition model 420 according to an embodiment of the present disclosure improves user convenience by accurately recognizing the user's intent. For example, first, if the user's utterance is “I need to refuel”, the sentence converted by the speech recognition module is “I need to refuel”. The user's intent is to find a gas station because the user needs to refuel. The response generated by the response generation module using the intent slot output by the natural language understanding module may be “To find a gas station near your current location, say ‘Add gas stations as stops’”. Second, if the user's utterance is “Do I need to refuel?”, the sentence converted by the speech recognition module is “Do I need to refuel?” The user's intent is to check whether or not refueling is currently required. The response generated by the response generation module using the intent slot output by the natural language understanding module may be “The current driving distance is x km. You will not run out of gas with the currently provided route”.

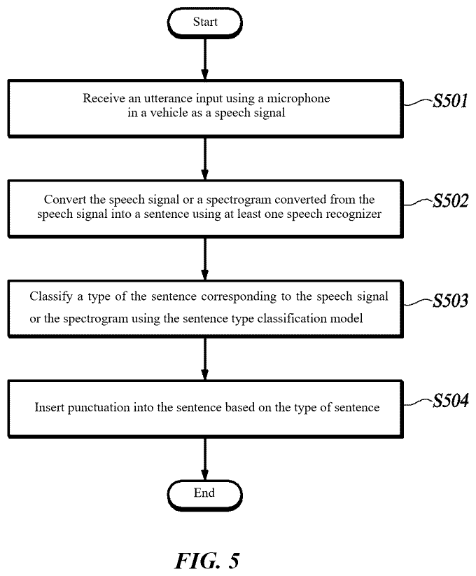

FIG. 5 is a flowchart illustrating a method for combining a transcribed utterance and punctuation according to an embodiment of the present disclosure.

Referring to FIG. 5, the speech recognition apparatus for combining a transcribed utterance and punctuation receives an input utterance using a microphone in a vehicle in the form of a speech signal (S501). The apparatus for combining a transcribed utterance and punctuation may receive a speech signal using the communication interface illustrated in FIG. 6.

The speech recognition module may convert the speech signal or a spectrogram converted from the speech signal into a sentence using at least one speech recognizer (S502). During the process of step S502, the speech recognition module may convert the speech signal or the spectrogram generated based on the speech signal into a sentence using a plurality of speech recognizers. The speech recognition module may select any one of results processed by the plurality of speech recognizers.

The sentence type classification model may receive the speech signal or the spectrogram generated based on the speech signal and classify the sentence into the type of sentence (S503). Sentence types may include a declarative sentence, an interrogative sentence, and an exclamatory sentence. The sentence type classification model may receive the speech signal or the spectrogram generated based on the speech signal and extract features, including at least one of a prosody or a pitch. The sentence type classification model may classify the sentence into the type of sentence based on the extracted features. The sentence type classification model may classify the type of sentence using the softmax function.

The speech recognition module may insert punctuation based on the type of sentence into the sentence selected from the processing result of at least one speech recognizer (S504). The speech recognition module may insert punctuation appropriate for the type of sentence into the selected sentence to combine the sentence and punctuation. If the type of sentence is an interrogative sentence, e.g., a question, or an exclamatory sentence, the speech recognition module may combine the selected sentence with punctuation appropriate for the type of sentence. If the type of sentence is an interrogative sentence, a question mark may be set as punctuation, and if the type of sentence is an exclamatory sentence, an exclamation mark may be set as punctuation.

FIG. 6 is a configuration diagram of a speech recognition apparatus according to an embodiment of the present disclosure.

Referring to FIG. 6, the speech recognition apparatus 600 may include some or all of a non-transitory memory 610, a processor 620, a storage 630, an input/output interface 640, and a communication interface 650.

The speech recognition apparatus 600 may be a stationary computing device such as a desktop computer, a server, or AI accelerator, or a mobile computing device such as a laptop computer or a smartphone.

The memory 610 may store a program that causes the processor 620 to perform the method of combining an utterance and punctuation according to an embodiment of the present disclosure. For example, the program may include a plurality of instructions executable by the processor 620, and the method of combining an utterance and punctuation may be performed by the processor 620 executing the plurality of instructions.

The memory 610 may be a single memory or a plurality of memories. When the memory 610 is a single memory or a plurality of memories, information required to combine an utterance and punctuation may be stored in the single memory or divided and stored in the plurality of memories. When the memory 610 is composed of a plurality of memories, the plurality of memories may be physically separated.

The memory 610 may include at least one of a volatile memory or a nonvolatile memory. The volatile memory may include a static random access memory (SRAM) or a dynamic random access memory (DRAM), and the nonvolatile memory may include a flash memory.

The processor 620 may include at least one core capable of executing at least one instruction. The processor 620 may execute instructions stored in the memory 610. The processor 620 may be a single processor or multiple processors.

The speech recognition module 110, the natural language understanding module 120, and the response generation module 130 may be implemented using the processor 620.

The storage 630 may maintain stored data even when power supplied to the speech recognition apparatus 600 is cut off. For example, the storage 630 may include a nonvolatile memory, or may include a storage medium such as a magnetic tape, an optical disk, or a magnetic disk.

A program stored in the storage 630 may be loaded into the memory 610 before being executed by the processor 620. The storage 630 may store a file written in a programming language, and a program generated from the file by a compiler or the like may be loaded into the memory 610.

The storage 630 may store data to be processed by the processor 620 and data processed by the processor 620.

The input/output interface 640 may include an input device such as a keyboard or a mouse and an output device such as a display device or a printer. A user may also trigger execution of a program by the processor 620 using the input/output interface 640.

The communication interface 650 provides access to an external communication network. For example, the speech recognition apparatus 600 may communicate with other devices using the communication interface 650.

Each element of the apparatus or method in accordance with the present disclosure may be implemented in hardware or software, or a combination of hardware and software. The functions of the respective elements may be implemented in software. A microprocessor may be implemented to execute the software functions corresponding to the respective elements.

Various embodiments of systems and techniques described herein may be realized with digital electronic circuits, integrated circuits, field programmable gate arrays (FPGAs), application specific integrated circuits (ASICs), computer hardware, firmware, software, and/or combinations thereof. The various embodiments may include implementation with one or more computer programs that are executable on a programmable system. The programmable system includes at least one specifically configured programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data may be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code may be stored and executed in a distributive manner.

Although operations are illustrated in the flowcharts/timing charts in this specification as being sequentially performed, this is merely a description of the technical idea of one embodiment of the present disclosure. In other words, those of ordinary skill in the art to which various embodiments of the present disclosure belong may appreciate that various modifications and changes may be made without departing from essential features of an embodiment of the present disclosure. In other words, the sequence illustrated in the flowcharts/timing charts may be changed and one or more operations of the operations may be performed in parallel. Thus, flowcharts/timing charts are not limited to the temporal order.

Although various embodiments of the present disclosure have been described for illustrative purposes, those of ordinary skill in the art should appreciate that various modifications, additions, and substitutions are possible, without departing from the idea and scope of the claimed disclosure. Therefore, various embodiments of the present disclosure have been described for the sake of brevity and clarity. The scope of the technical idea of the present embodiments is not limited by the illustrations. Accordingly, one of ordinary skill in the art would understand that the scope of the claimed disclosure is not to be limited by the above explicitly described embodiments but by the claims and equivalents thereof.

What is claimed is:

1. A method for combining a transcribed utterance and punctuation using a pre-trained sentence type classification model, the method comprising:
receiving, from a microphone in a vehicle, a speech signal representing an input utterance captured by the microphone;
converting the speech signal or a spectrogram generated based on the speech signal into a sentence using at least one speech recognizer, wherein the sentence represents a transcription of the input utterance to text;
classifying the sentence into a type of sentence corresponding to the speech signal or the spectrogram using the pre-trained sentence type classification model;
inserting punctuation into the sentence based on the type of sentence; and
generating a text-based combined result based on a combination of the sentence and the inserted punctuation.

2. The method of claim 1, wherein converting the speech signal or the spectrogram comprises converting the speech signal or the spectrogram into sentences using a plurality of speech recognizers and selecting one of the sentences converted by the plurality of the speech recognizers.

3. The method of claim 1, wherein classifying the sentence using the pre-trained sentence type classification model comprises:
receiving the speech signal or the spectrogram, processing a waveform of the speech signal or the spectrogram, and extracting features including at least one of a prosody or a pitch; and
classifying the sentence based on the extracted features.

4. The method of claim 3, further comprising:
receiving, by a layer of the pre-trained sentence type classification model, the speech signal or the spectrogram;
processing, by the layer of the pre-trained sentence type classification model, a waveform of the speech signal or the spectrogram; and
extracting, by the layer of the pre-trained sentence type classification model, the features.

5. The method of claim 1, wherein the type of sentence includes a declarative sentence, an interrogative sentence, and an exclamatory sentence.

6. The method of claim 1, wherein inserting punctuation into the sentence comprises inserting the punctuation into the sentence when the type of sentence is an interrogative sentence or an exclamatory sentence, setting the punctuation as a question mark when the type of sentence is an interrogative sentence, and setting the punctuation as an exclamation mark when the type of sentence is an exclamatory sentence.

7. The method of claim 1, further comprising generating the spectrogram by converting the speech signal received from the microphone into the spectrogram.

8. The method of claim 1, further comprising generating a text-based response output based on the text-based combined result.

9. The method of claim 8, further comprising displaying the text-based response output in a display device of the vehicle.

10. The method of claim 8, further comprising generating and transmitting a result processing signal based on the text-based response output to control the vehicle.

11. An apparatus for combining a transcribed utterance and punctuation using a pre-trained sentence type classification model, the apparatus comprising:
a memory configured to store computer-executable instructions; and
at least one processor configured to execute the computer-executable instructions to:
receive a speech signal from a microphone in a vehicle, the speech signal representing an input utterance captured by the microphone;
convert the speech signal or a spectrogram generated based on the speech signal into a sentence using at least one speech recognizer, wherein the sentence represents a transcription of the input utterance to text;
classify the sentence into a type of sentence corresponding to the speech signal or the spectrogram using the pre-trained sentence type classification model;
insert punctuation into the sentence based on the type of sentence; and
generate a text-based combined result based on a combination of the sentence and the inserted punctuation.

12. The apparatus of claim 11, wherein the processor is further configured to:
implement a plurality of speech recognizers configured to convert the speech signal or the spectrogram into sentences; and
select one of the sentences converted by the plurality of the speech recognizers.

13. The apparatus of claim 11, wherein the processor is further configured to use the pre-trained sentence type classification model to:
receive the speech signal or the spectrogram and extract features including at least one of a prosody or a pitch; and
classify the sentence based on the extracted features.

14. The apparatus of claim 13, wherein the pre-trained sentence type classification model includes a layer configured to receive the speech signal or the spectrogram, process a waveform of the speech signal or the spectrogram, and extract the features.

15. The apparatus of claim 11, wherein the type of sentence includes a declarative sentence, an interrogative sentence, and an exclamatory sentence.

16. The apparatus of claim 11, wherein the processor is further configured to insert the punctuation into the sentence when the type of sentence is an interrogative sentence or an exclamatory sentence, set the punctuation as a question mark when the type of sentence is an interrogative sentence, and set the punctuation as an exclamation mark when the type of sentence is an exclamatory sentence.

17. The apparatus of claim 11, wherein the processor is further configured to generate the spectrogram by converting the speech signal received from the microphone into the spectrogram.

18. The apparatus of claim 11, wherein the processor is further configured to generate a text-based response output based on the text-based combined result.

19. The apparatus of claim 18, wherein the processor is further configured to display the text-based response output in a display device of the vehicle.

20. The apparatus of claim 18, wherein the processor is further configured to generate and transmit a result processing signal based on the text-based response output to control the vehicle.
